(19) United States
(12) Patent Application Publication
(10) Pub. No.: US 2010/0257061 A1
(43) Pub. Date: Oct. 7, 2010

(54) SYSTEM AND METHOD FOR EXCHANGING INFORMATION ON MUSIC SERVICES

(76) Inventor: KENNETH MARLO FRIERSON, CHARLOTTE, NC (US)

Correspondence Address: Kenneth Marlo Frierson, 1116 Red Hill Road, Charlotte, NC, 28216, US

(21) Appl. No.: 12/754,725

(22) Filed: Apr. 6, 2010

Related U.S. Application Data
(60) Provisional application No. 61/167,190, filed on Apr. 7, 2009.

(51) Int. Cl. G06Q 30/00; G06Q 50/00; G06Q 20/00

(52) U.S. Cl. 705/14.71; 705/27

(57) ABSTRACT

A virtual platform associated with a data processing system is provided for allowing the music industry professionals and businesses to connect and interact for achieving collaborative services to deliver cost effective and efficient solutions. The virtual platform may include a posting module and a bidding module allowing the music industry professionals and business for posting and bidding for plurality of music related services hosted on the virtual platform. The virtual platform also enables an artist and the owners of the music organization to interact among them using the virtual platform services such as private message board, or through email, mobile, telephone.

### FIELD OF THE INVENTION

The present invention relates to a services network, more particularly to a method and system adapted to provide a network for exchanging information on music services for delivering cost effective and efficient solutions to the music industry.

### BACKGROUND OF THE INVENTION

The music industry is becoming extremely challenging and competitive to operate day by day due to the cost incurred for running such an industry. Music connoisseurs are demanding variety in music at cheaper prices. So, the music industry is looking for options to cater to demands of the music connoisseurs in a cost effective and efficient manner.

Piracy also has become a threat to the music industry. Music industry is heavily losing revenue due to illegal download of music related works. Piracy has caused major reduction in the profitability of the music industry. Also, cost for manufacturing, marketing, distributing, producing in music industry have increased astronomically.

Similarly, the artists who perform individually and try to distribute their albums are also finding it difficult to control cost. Hence, it is evident that in the music industry there is a need for cost saving methods for both individual artists and owners of music organizations.

Also, both the artists and the owners of music organizations sometime face difficulty in interacting among themselves to address issues related to cost because of geographical constraints, lack of marketing, distribution, and production capabilities in many geographies. All these reasons make their presence geographically restricted to their local regions they are associated with and also make it extremely difficult for them to generate or venture into new horizons of the music business.

Therefore, a method and system is required where a music organization/label company can collaborate with remotely located artists and service provider in the music industry to work on music related services including manufacturing, marketing, distribution, production and the like.

### SUMMARY OF THE INVENTION

According to an embodiment of the present invention, a system for exchanging information and bidding for music based services is provided. The system comprises a data processing system which is configured to store information relating to one or more services defined by a first party. The data processing system further provides a posting module that allows the first party to post the details of the one or more services over a virtual platform. The virtual platform is also accessible to one or more other parties for exchanging information relating to the one or more services. Further, the system also comprises a bidding module which allows the one or more other parties to bid for the one or more services over the virtual platform. The system is also configured to store the information relating to the bids made by the one or more other parties and the corresponding information relating to the one or more bidding parties. The data processing system is further configured to processes the information relating to the bids and the one or more other parties to assist the first party in selecting the winning bid for each service.

According to another embodiment of the present invention, a method for exchanging information and bidding for music based services is provided. The method includes defining one or more music based services by a first party and storing the information relating to the one or more services at a first server associated with the data processing system. The one or more services can be posted over a virtual platform associated with the data processing system. The posted services on the virtual platform are accessible to one or more other parties. Further, the one or more other parties can also request information relating to the one or more services from the first party and subsequently bid for the one or more services based on the information received. The method also provides for storing information relating to the bids made by the one or more other parties and information relating to the bidding parties at a second server associated with the data processing system. The method also provides for processing the information relating to the bids and the one or more other parties using the data processing system and allows the first party to select winning bids for each service based on the processed information.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a system illustrating a virtual platform used for a collaborative services related to a music industry, in accordance with an exemplary embodiment of the present invention;

FIG. 2 is a block diagram of a system illustrating a bidding & posting interfaces offered by the virtual platform for collaborating music industrial artists and companies, in accordance with an exemplary embodiment of the present invention;

FIG. 3 is a flow diagram illustrating a method of bidding for music related services by an artist and companies, in accordance with an exemplary embodiment of the present invention; and

FIG. 4 is a flow diagram illustrating a method of posting for music related services by an artist and companies, in accordance with an exemplary embodiment of the present invention.

### DETAILED DESCRIPTION OF THE INVENTION

The following description is full and informative description of the best method and system presently contemplated for carrying out the present invention which is known to the inventors at the time of filing the patent application. Of course, many modifications and adaptations will be apparent to those skilled in the relevant art. While the method and object described herein are provided with a certain degree of specificity, the present invention may be implemented with either greater or lesser specificity, depending on the needs of the user. Further, some of the features of the present invention may be used to advantage without the corresponding use of other features described in the following paragraphs. As such, the present description should be considered as merely illustrative of the principles of the present invention and not in limitation thereof.

According to an embodiment of the invention, the first party defining the music related services can be either an artist or a company desirous to provide services in creation of music, recording of music, distribution of music, marketing of music and the like. At the same time the one or more other party correspondingly can be either of the artist or the company capable of offering solution for the desired services. For the description of the invention the term ‘parties’ will be interchangeably be used for artists, music companies, recording organizations, and label companies. It should be appreciated that the ‘parties’ can also be people who are not related to the music industry but require the need of such music based services.

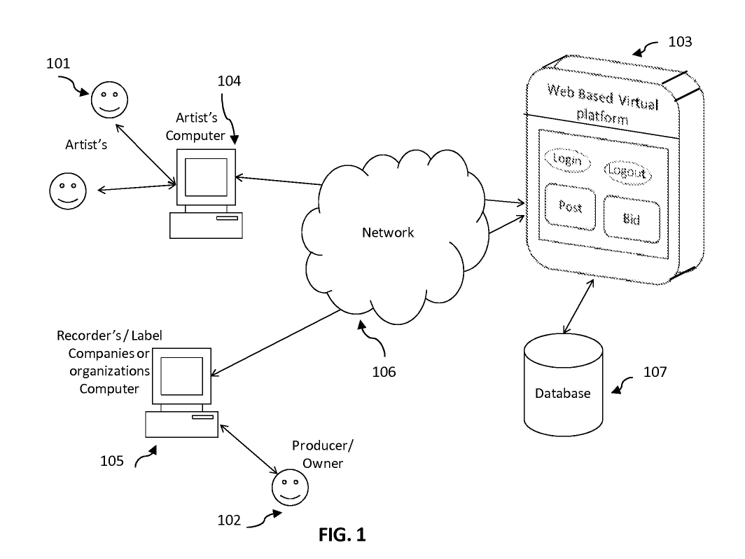

Referring to figures, FIG. 1 is a block diagram of a system illustrating a virtual platform 103 used for a collaborative services related to a music industry. According to one embodiment of the present invention, the artists 101 or the companies 102 desirous to provide services in at least one of creation of music, recording of music, distribution of music and marketing of music can approach the virtual platform 103 associated with a data processing system for posting various music related services. The artist 101 may be an individual related to the music industry having the abilities to offer such music related services to one or more other parties which may include the company 102 like a recording organization or a label company having the need to use such music related projects. At the same time, the company 102 may offer such music related services which the artist 101 may need to use.

In another embodiment of the present invention, the artist 101 can be a musician, a singer, a person with singular characteristics useful in creation of music based services, for example an instrument player, a support worker in the similar services, a distributor, a marketing professional in music industry. The organization 102 may be a label or a record company and may include a group of artists and necessary infrastructure and is engaged in creation of music, songs, or other services related to music industry including at least one of a distribution or marketing or manufacturing services.

In a further embodiment of the present invention, the artist 101 and the organization 102 may either post the music related services they are willing to offer or even bid for the music related services they are interested to work. The posting or bidding of the music related services may be performed using a virtual platform 103 associated with the data processing system. In one embodiment of the present invention, the virtual platform 103 is web based.

The artist 101 or owners of the organization 102 interested in the music related services hosted on the virtual platform 103 may use a device to communicate with a web based virtual platform 103. The artist's or the owner's device 105 and may be a computer, a laptop, a mobile device adapted to browse a website, a PDA and the like. The web based virtual platform 103 facilitates bidding and posting i.e. gathering relevant information about the music related services. The bidding is a competitive bidding process and the artist 101 may bid for one or more music related services using his device. As apparent to those skilled in the art of music art, the music related services and projects include, but are not limited to, music composition, singing, song creation, instrument playing, distribution/marketing/manufacturing of music related items, funding for music related services and the like. The communication between the artist 101 and the organization 102 may be enabled through the virtual platform 103 using a network 106. As apparent to those of skilled in the art, the network 106 may be an internet, using at least one of a secure layered protocol. The network may be enabled by using wireless, WAN, LAN or the like.

According to another embodiment of the present invention, the system includes at least one of a posting module and a bidding module. Both the modules are associated with the data processing system. The posting module includes provision for posting for music related services offered either by the artist 101 or the organization 102. Similarly, the bidding module includes provision for bidding for music related services offered either by the artist 101 or the organization 102. According to one embodiment of the present invention, the posting and the bidding module are stand alone modules enabled to perform respective activities. Alternatively, the posting and the bidding modules may be a single module wherein the single module is enabled to perform activities related to both posting and bidding activities for music related services.

According to an embodiment of the present invention, the system includes a first server 107 for storing information relating to the project defined by the first party. The first server 107 is capable of storing a variety of valuable information, for example, but not limited to, the proposed music related services expected to be performed, the duration of the completion of the work, the total compensation, qualification for the bidders required, the cut-off date for the bid and other controlling factors.

According to one embodiment of the present invention, the system includes a bidding module for allowing the artist 101 and the organization 102 to bid and a second server 107 to store corresponding bid information. The virtual platform 103 is also capable of displaying a variety of valuable information, for example, but not limited to, the proposed music related services expected to perform, the duration of the completion of the work, the total compensation, and qualification for the bidders.

The system may also include endorsing a context or non-context base advertisements. A context based advertisement includes advertisement related a particular requirement. For instance, if an artist selects a guitar based musical services, the related advertisement of guitars i.e., various types of guitars, players of the guitar, manufacturing of guitars, and alternate instruments for the guitars and the like is displayed on the said virtual platform. Alternatively, the system may be configured to display non-context advertisement of a music work. For example, for a guitar based musical works, an advertisement on musical drums and the like can also be displayed.

Additionally, the system is enabled to facilitate various activities such as creation of artist's profile, bidding options, receiving feedback and ratings provided for previously completed work are a few of the examples. The information of various activities may be stored in the server memory.

Similarly, the system includes a posting module for allowing the artist and the organization to post the music related services and the database to store information related to music services. The posting module provides provision for posting the music related services for the artist and the organizations.

The post related to music related service further includes providing additional information such as total compensation being paid e.g., US$ 2000, timeframe of completion e.g., 6 months, duration of the posted bid being opened e.g., from 15 minutes to 30 days, minimum qualification and experience of artist and optionally sample of work and other related information. When the interested party intends to bid for music related service, they can access the virtual platform and the post is displayed at their device using which they may bid for the services there are interested in. Thus, the present invention provides an opportunity for collaboration of the music related services providers i.e. the organization and artists located at different geographies to connect and interact under one virtual platform.

Additionally, the virtual platform 103 provides login services to the artists 101 and organizations 102. The login services enable the artists 101 and organizations 102 to create a login based access account. The access account of the artist 101 or label organizations 102 enables them to create a profile indicating qualifications and experience, contact details, billing type and rate, and the like. Optionally, the virtual platform 103 allows premium services wherein the artist 101 or the organization 102 may also upload sample work which is being stored at the server memory of the system.

Therefore, the virtual platform 103 enables the artists 101 and the companies 102 to contact and collaborate with a remotely located corresponding artist and company to complete the said services cost effectively and timely. The owners of the proposed musical related services forgo any escalation in price incurred due to technology up gradation or staff maintenance. It also enables an owner of the said proposed music related services to exploit talent of artists located remotely. Additionally, the music based bidding model assists owners in generation of remote markets by associating with distributor existing at remotely accessible geographies.

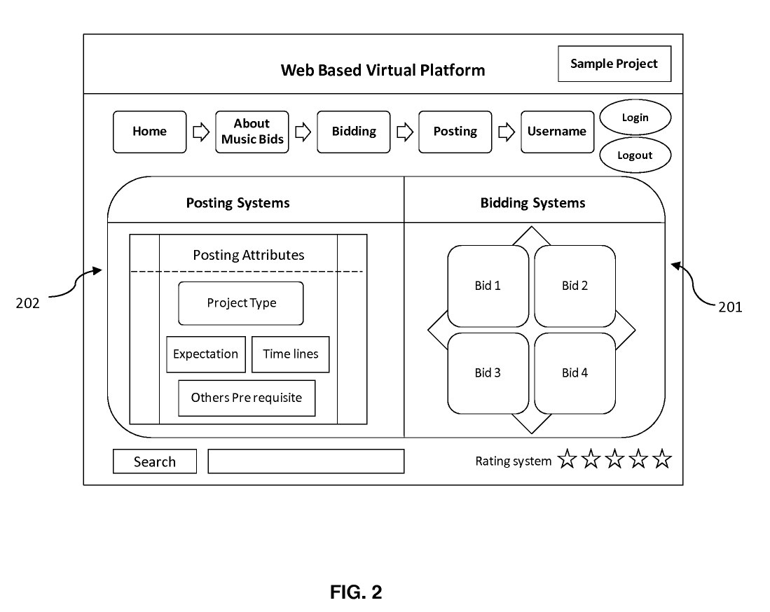

FIG. 2 is a block diagram of a system illustrating posting and bidding interfaces offered by the virtual platform 103 for collaborating music industrial artists 101 and companies 102, in accordance with an exemplary embodiment of the present invention. The virtual platform 103 includes a bidding system 201, and a posting system 202 hosted on a website 103 to support bidding and posting of music related services. The virtual platform 103 additionally includes a database memory 107 (as shown in FIG. 1) for storing music related service data and the bid information. Also, the memory 107 stores information related to the profiles of the artists and the owners of the organizations. Additionally, the virtual platform 103 facilitates generation of list of music related services posted by the counterparts. Further, the virtual platform 103 also enables generation of list of bidders created by the artists 101 or the companies 102.

The elements of the virtual platform 103 displayed herein are just an example and may be showed and designed in various different ways, based on one's interest and taste in the domain. Also, the virtual platform 103 may include additional elements, which may or may not have been detailed while describing the context of the present invention. However, mere addition of such components should not restrict the scope of the present invention.

From a perspective of an artist or companies interested in bidding for a music related service accesses the virtual platform website 103 by logging into the website 103. According to one embodiment of the present invention, the artist 101 may create his profile on the said virtual platform. While creating his profile, the artist 101 may include at least one of qualifications and experience, list of types of work completed, location, contact details (such as email, mobile number etc.), milestones achieved, award won and other similar feature to display capabilities and potential.

Upon logging into website, the artist 101 is displayed one or more elements of the virtual platform 103, which includes at least one of option to search enabling easy searching of music related services. Additionally the artist 101 may be provided a list of music related services posted by owners of the organization 102. The proposed music related services as provided by the owners of the organization 102 may include detailed information about the type of work (i.e. project type), the timeframe of completion of the said work (i.e. time lines), billing cost and method (i.e. expectation), qualification, experience, location of the artist (i.e. Other Pre requisite). The type of work indicates if the proposed music related services are for creation of music, composition of a song, support services in music industry, distribution of music related items are few of the examples but not concluded. The timeframe for the completion of work indicates time allowed to submit the completed work. For instance, music related service may be desired to be completed within a timeframe of 6 months. The music related service can be submitted electronically or can be embedded in CD, DVD or hardware and shipped to the work owner. The billing cost and method for the said music related service indicates total cost proposed to pay for the music related said services or hourly billing method for said music related service. The qualifications and experience indicates abilities of the artist while location indicates the place said artist belongs to. These details may assist owners for the said proposed music related service to limit the number of bidding artists.

The artist 101 may bid for a music related service he may be interested in by selecting from a displayed list of music related services posted on the virtual platform 103. Each party may be allowed to bid only once for the posted project. The number of bids displayed on the web interface of the virtual platform 103 may not be enabled for the particular artist to view. During bidding or after bidding for a music based work, the party may be required to provide additional clarifications or information. The present virtual platform is an interactive platform. For any clarifications or information, during bidding process or after bidding for the selected music related service, the artist 101 may contact the owner of the music related service using an interactive facilities provided by the virtual platform 103 such as private message board, or through email, mobile, telephone—as per the consent of the owner of the music related service.

According to one embodiment of the present invention, if the owner of the music related service has allocated the said work to an artist, the artist diligently completes the said work, and provides the completed work electronically or embeds it in hardware like a CD or a DVD and ships it using courier services and the like. Additionally, the party may request owner of the proposed music related service to provide his feedback and rating based on their satisfaction level.

The party may also post for the music related service he is interested in by providing the details of music related services on the virtual platform. The artist may have to provide the detailed information about the type of work (i.e. project type), the timeframe of completion of the said work (i.e. time lines), expected billing cost and method (i.e. expectation), qualification, experience, location of the companies (i.e. Other Pre requisite).

Additionally, the party may request to make payment using PayPal, credit card, debit card, check, money transfer, wire transfer and the like for the music related service, which the party has successfully executed.

The party may additionally showcase the sample project details to indicate either the quality of work they are capable of providing or to indicate the quality of work they expect from the bidding party.

According to another embodiment of the present invention, from a perspective of an artist's or owner interested in posting for a music related service accesses the virtual platform website by logging into the website. According to one embodiment of the present invention, the owners of the organization may create their profile on the said virtual platform. The owner may be an individual person or a label/recording organization. While creating their profile, the owners may include at least one of qualifications and experience, list of types of work completed, location, contact details (such as email, mobile number etc), milestones achieved, award won and other similar feature to display capabilities and potential.

In a further embodiment of the present invention, the owners of the organization may post for the music related service, seeking for bid from a plurality of artist. While seeking exploitation of remotely available artist's work, the owner of the said music related service posts the specific requirement on the said virtual platform and request artists to bid on it. Apart from the details on music related service (i.e. project details), the owner may provide additional information such as timeframe of completion (i.e. time lines), total cost they may afford for the said music based work (i.e. expectation), expected qualification and experience of the artists, location of the bidder, sample work and the like (i.e. others pre requisite). On receiving the bids from multiple artists, the owner may analyze the artist's qualification and experience, location, sample work, any summary shared by artist, previous feedback and ratings and the like. Subsequently, the owner may allocate the music related service to one or more artists and optionally reviews the work periodically. Thereafter, once the owner receives the completed music related services from one or more artists or companies. The owner may review the same and optionally requests them to make necessary changes if required. On completion of the said services, the owner makes the payment using PayPal, credit card, debit card, check, money transfer, wire transfer and the like. Optionally, the owner may also provide feedback and rating for the completed music related service indicating his satisfaction level. For example, in a scale of one to five from not satisfied to excellent, a rating of one indicates unsatisfactory or poor quality of work and conversely a rating of five indicates high satisfaction.

Similarly, the owners of the music organization may bid for the music related service posted by the artists in the virtual platform. Each owners may be allowed to bid only once for the posted project. The number of bids displayed on the web interface of the virtual platform may not be enabled for the particular owners to view. During bidding or after bidding for a music based work, the owners may be required to provide additional clarifications or information based on the requirement of the artist, which the owner may accomplish by using the interactive facilities provided by the virtual platform such as private message board, or through email, mobile, telephone—as per the consent of the artist.

The owners and the artist may communicate with each other through their respective web enabled devices over a network. The devices may include a personal computer, a laptop, a PDA or blackberry or any such web enabled devices. The network may be a secure network using a secure layered protocol. The owners and the artist may logout from the virtual platform after posting and bidding for the music related services hosting in the virtual platform.

Therefore, the virtual platform provides an opportunity to owners and artists to collaborate with each others for easy flow of the music related work. Additionally, the virtual platform provides an opportunity to the owner to collaborate with distantly available resources in product manufacturing, product distribution, music recording, and endorsement of products, networking with studios, promotional companies and artists at minimum loss of time.

In another embodiment of the present invention, the artist or the owners may be provided with an acknowledgment on posting or bidding for a music related service in the virtual platform. The virtual platform may include an alert system to bidder if a matching music related service is posted in the virtual platform. The alert system may notify bidders that a particular item of interest is about to be offered for bid as a part of a virtual auction program. The system may also provide bidders a means for inputting proxy bids, in case of non-availability of the artist or the owner for bidding.

Further, the virtual platform maintains a record of bidders and posters in the database. The maintenance of record of all bidders and poster are important to track them back, if case any litigation arises in future for non-payment or for non-complying with the necessary copyrights rules. Also, maintaining the records is important to take the bid to the next level either for delivery of consignment or information via courier etc.

The bid details are maintained and displayed in the virtual platform to assist both the poster and bidder to get sufficient idea about the budget involved for each type of music related service. Post the bidding window time, the virtual platform may terminate the acceptance of the bid or may terminate the bid obtained after the completion of bid's last date.

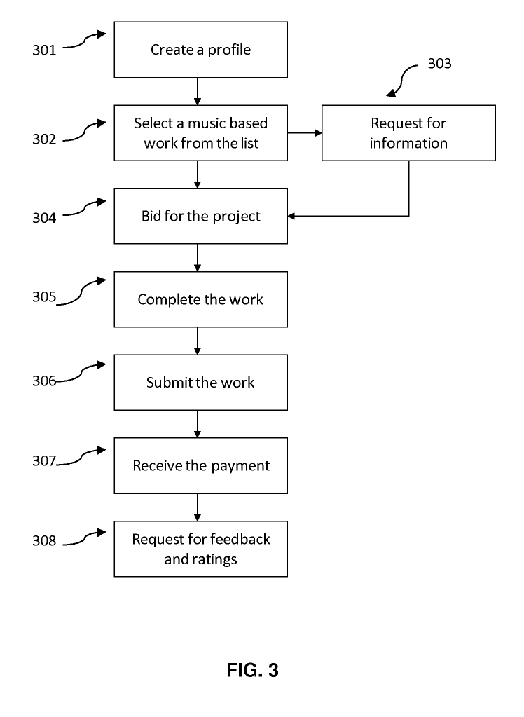

FIG. 3 is a flow diagram illustrating a method of bidding for music related services by an artist and companies, in accordance with an exemplary embodiment of the present invention. The virtual platform 103 facilitates the artist 101 and the owners 102, to bid for music using the following steps, profile creation 301, selecting a music related service 302, viewing requirement for music related service 303, bidding for a music related service 304, completing the work 305, submitting the work 306, receiving payment 307 and requesting for feedback and ratings 308. An artist may be an individual artist or an organization may be a label company or recording company comprising one or more artists. During the step 301 of creation of profile, the artist or owners may create a login based access account by paying nominal fee for the virtual platform. The artist or owners may include at least one of a qualifications and experience, list of types of work completed, location, contact details (such as email, mobile number etc), milestones achieved, award won and other similar feature to display his capabilities and potential. Further, the virtual platform 103 enables an artist or owners to edit their profile time and again over a period. The login account is level based. The level of account may have different subscription fee and access privilege depends on the type of account the artist or the owners holds. Alternatively, the artist or owners may bid for a proposed music related service without creating a login based account. The artists or owners may opt to select a bid directly and provides his credentials and contact details along with other required details and submit the bid for the proposed work.

Following the creation of profile, in the step 302 the artist or owners may select one or more music related service from a list of the proposed music related services. The list of proposed music related services may be generated at multiple levels. For example, a search facility may be provided by the said virtual platform wherein an artist or owners may input keywords based on genre of music or type of interested work related to music. Additionally, a list may also be provided comprising similar or all music related service. The artists or owners may select one or more music related services which interest them to work on.

Subsequently, at the step 304 they submit the bid for the proposed music related services. However, in between at the step 303 they may request for additional information about the select proposed music related service before submitting the final bid. The request for additional information includes, but not limited to, on the genre of the music, billings, duration of completion, and the like. The additional information enables them to gain sufficient confidence and clarity before bidding for the work on the said proposed music related service. They may also request additional information after submission of bid or during working on said proposed music related service or after completion of the said proposed music related service. The communication may be done using private message board provided by virtual platform or through email or telephone or the like as shared by the owner or artist of the proposed music based work.

Thereafter, upon completion of bidding for the said music related service they may submit the bid through the virtual platform. The plurality of such submitted bids are reviewed and one or more artists or owners may be handed over the music related work. At the steps 305 and 306 the artist or the owners after completion of the music related services, submit the work through the virtual platform. Additionally they may submit the allocated work in parts as defined and proposed initially or as per their later discussions. Submission work may be reviewed to assess the quality of services.

Subsequently, at the step 307 the artist or the owner of the proposed music related service may be paid for their services based on the mode payment selected by them. The mode of payment may comprise, but not limited to, PayPal, credit card, debit card, check, money transfer, wire transfer and the like. Optionally, at the step 308 the artist or owners may request to provide feedback and rating on their completed work. The feedback and rating on the completed work may display the satisfaction level of the client i.e., owner or the artist of the proposed music related service.

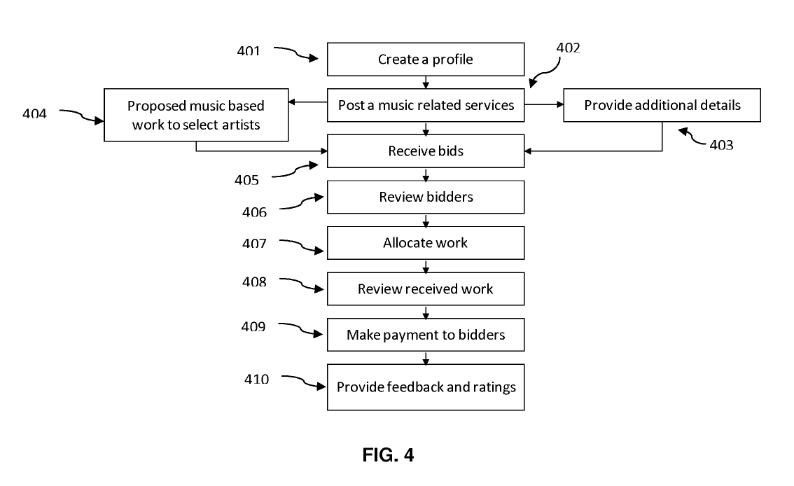

FIG. 4 is a flow diagram illustrating a method of posting for music related services by an artist and companies, in accordance with an exemplary embodiment of the present invention. As it is not hidden to anyone regarding the high pricing of well famed artists, high cost of maintaining a staff, high manufacturing cost, high distribution and marketing cost, non-availability of a desired artistic talent in a select geography, maintaining low cost of budget and the like, the owners of musical based works are driven to think out-of-box. Also, changing demands of music connoisseur and increasing market competitiveness has further compelled the owner of music based works or artist to produce new things continuously.

The owners of the music based works include an individual artist or a recording or label company or service providing company in music industry. Collectively, it creates a big challenge to the owners of music based work. However, the advent of internet has provided an opportunity to the owners of the music industry or the artist to collaboratively work with each others. A virtual platform hosted on a website is provided for collaborating the artist and the owners under one roof. The owners or artists seeking completion of a desired work may create a login access based profile on the said virtual platform at step 401. Additionally, the owners or artist works may include “who they are”, “what they do”, their market, contact details such as email, mobile, telephone, and the like. The details of desired music related services may be posted on the virtual platform at step 402 and 403. The details of desired music based includes, but not limited to, type of work (i.e. project details), timeframe of work (i.e. time lines), expected qualification (i.e. expectations) and experience of artist, total expected cost, delivery process, payment method, and the like (i.e. other pre requisite). The said details may function as controlling factors and may exclude bidding artists or owners who do not match the details at step 404. Similarly, the said details may compel the bidding system to provide a list of artists or owners whose profiles created on said virtual platform are matching to the said details. The owners or artist of the said music related services may further encourage other counterpart to raise any information or clarification and provide information on discretion. The communication between owners and artist of the said proposed music related services may be initiated as described anywhere in the earlier sections.

Alternatively, they may search for profiles of other counter parts created on the said virtual platform and request the one or more of them to bid for their proposed music related work.

Subsequently, on receiving bids from the artist or owners at step 405, the bidders for the proposed music relates services, the owners or artist may evaluate the counter parts profile based at least part on qualification and experience, previous feedbacks and ratings, timeframe within which an artist can complete the work, total billable cost, location, sample work, and the like at step 406. Thereafter, the proposed music based work may be allocated to one or more artists or owners at step 407. The artists or owners may communicate to the other counter part while working on the proposed music related service. On completion of the allotted music related service, the artist or owners may performs the requisite task to cross verify whether all necessary tasks are performed or not and submit it to the other counter part for review. The owner or artist may review the work and may propose to make changes if necessitated at step 408. On successful completion and review of the work the payment may be made to the artist or owners at step 409 and they may optionally provide feedback and ratings to the artist or owners works at step 410, which may be displayed with the profile of the artist or the owner.

As will be appreciated by those ordinary skilled in the art, the foregoing example, demonstrations, and method steps may be implemented by suitable code on a processor base system, such as general purpose or special purpose computer. It should also be noted that different implementations of the present invention may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

Many modifications of the present invention will be apparent to those skilled in the art to which the present invention applies. Further, it may be desirable to use some of the features of the present invention without the corresponding use of other features.

Accordingly, the foregoing description of the present invention should be considered as merely illustrative of the principles of the present invention and not in limitation thereof.

I/We claim:

1. A system for exchanging information and bidding for music based services, the system comprising:
a. a data processing system;
b. a first server, associated with the data processing system, for receiving and storing information relating to one or more music based services defined by a first party, wherein the first server comprises at least one data memory for storage of information;
c. a posting module, associated with the data processing system, configured to allow the first party to post the music based services over a virtual platform associated with the data processing system and in communication with the first server, the virtual platform also being accessible to a second party for exchange of information relating to the music based services, wherein the first party maintains control over the one or more services and the second party has regulated access to the music services over the virtual platform;
d. a bidding module, associated with the data processing system, for allowing the second party to request information relating to the music based services from the first party and subsequently bid for the music based services based on the information received over the virtual platform;
e. a second server associated with the data processing system and in communication with the virtual platform, for storing information relating to the bids made by the second party and information relating to the second party, wherein the second server comprises at least one data memory for storage of information; and
f. a processing module associated with the data processing system for processing the information relating to the bids and the second party and assisting the first party to select the winning bid based on the processed information.

2. The system of claim 1, wherein the one or more music services include at least one of, recording of music, distribution of music, marketing of music, music composition, singing, song creation, instrument playing, manufacturing of music related items, and funding for music related services.

3. The system of claim 1, wherein the virtual platform is web based.

4. The system of claim 1, wherein the parties use a device to communicate with the virtual platform, the device includes at least one of a computer, a laptop, a mobile device adapted to browse a website, and a PDA.

5. The system of claim 1, wherein the information relating to the music related services include the details of the service expected to be performed, the duration of the completion of the service, qualification for the bidders required, and the cut-off date for the bid.

6. The system of claim 1, wherein the virtual platform provides login services to the parties involved.

7. The system of claim 1, wherein the virtual platform provides an interface to the second party, the interface providing options for profile creation, editing, selecting the music related service, bidding for the music related service, and viewing requirements of the music related services.

8. The system of claim 1, wherein the second party is provided a rank based on the quality of the execution of services.

9. The system of claim 1, wherein the first party makes a payment for the services using PayPal, credit card, debit card, check, money transfer, and wire transfer.

10. A method for exchanging information and bidding for music based services over a data processing system, the method comprising:
a. defining one or more music based services by a first party;
b. storing information relating to the music based services at a first server associated with the data processing system, wherein the first server comprises at least one data memory for storage of information;
c. posting the music based services over a virtual platform, associated with the data processing system and in communication with the first server, the virtual platform being accessible to second party for the exchange of information relating to the music based services, wherein the first party maintains control over the music based services and the second party have regulated access to the music based services over the virtual platform;
d. allowing the second party to request information relating to the music based services from the first party and subsequently bid for the music based services based on the information received;
e. storing information relating to the bids made by the second party and information relating to the second party at a second server associated with the data processing system and in communication with the virtual platform, wherein the second server comprises at least one data memory for storage of information;
f. processing the information relating to the bids and the one or more other parties using the data processing system; and
g. allowing the first party to select winning bids for each project based on the processed information.

11. The method of claim 10, wherein the one or more music services include at least one of, recording of music, distribution of music, marketing of music, music composition, singing, song creation, instrument playing, manufacturing of music related items, and funding for music related services.

12. The method of claim 10, wherein the virtual platform is web based.

13. The method of claim 10, wherein the parties use a device to communicate with the virtual platform, the device includes at least one of a computer, a laptop, a mobile device adapted to browse a website, and a PDA.

14. The method of claim 10, wherein the information relating to the music related services include the details of the service expected to be performed, the duration of the completion of the service, qualification for the bidders required, and the cut-off date for the bid.

15. The method of claim 10, wherein the virtual platform provides login services to the parties involved.

16. The method of claim 10, wherein making the payment by the first party using PayPal, credit card, debit card, check, money transfer, and wire transfer.

17. The method of claim 10, wherein the second party is ranked based on the quality of the execution of the services.

18. The method of claim 10, wherein the virtual platform provides an interface to the second party, the interface providing options for profile creation, editing, selecting the music related service, bidding for the music related service, and viewing requirements of the music related services.
